(19) United States
(12) Patent Application Publication
(10) Pub. No.: US 2014/0185422 A1
(43) Pub. Date: Jul. 3, 2014

(54) INFORMATION RECORDING MEDIUM, INFORMATION RECORDING METHOD, AND INFORMATION RECORDING APPARATUS

(71) Applicant: Panasonic Corporation, Osaka (JP)

(72) Inventors: Isao Kobayashi, Osaka (JP); Yasumori Hino, Nara (JP)

(21) Appl. No.: 13/883,080

(22) PCT Filed: Sep. 26, 2012
(86) PCT No.: PCT/JP2012/006121

§ 371 Date: May 2, 2013

(30) Foreign Application Priority Data
Oct. 4, 2011 (JP) 2011-220157

(51) Int. Cl. G11B 7/24085

(52) U.S. Cl. CPC G11B 7/24085
USPC 369/124.04; 369/124.01

(57) ABSTRACT

Disclosed is an information recording medium (1) having a plurality of pits (301) which are formed periodically, wherein information is recorded by irradiating a laser beam onto a pit string constituted by the plurality of pits (301) and changing the shape of the pits (301), the pit string is periodically wobbled, a length of a period (fp) of the pits (301) is a diffraction limit of the laser beam or less, and the period of the pit string is n times (n is a positive integer) of the period of the pits.

### TECHNICAL FIELD

The present invention relates to an information recording medium having an information recording surface where information can be optically recorded, an information recording method for recording information on the information recording medium, and an information recording apparatus for recording information on the information recording medium.

### BACKGROUND ART

As information recording media for storing images and data, optical disks, such as DVD and Blu-Ray Disc (hereafter BD) are now used, where it is demanded to increase recording density in order to record larger volumes of information. In the case of optical disks, information is recorded by creating recording marks and spaces in a recording layer. Higher density recording has been implemented thus far by decreasing the sizes of the recording marks and spaces.

Recently BDXL disks having high recording density are on the market. A recording density on one layer of BDXL is approximately 33.4 GB. In BDXL, the sizes of the shortest recording mark and space are smaller than the diffraction limit of light. Generally a signal amplitude of a reproduced signal becomes 0 when recording marks and spaces shorter than the diffraction limit are reproduced, whereby a recording mark and space cannot be distinguished. In BDXL, the only recording marks and spaces shorter than the diffraction limit are the shortest recording marks and spaces, and the PRML (Partial Response Maximum Likelihood) technique is applied to the reproduced signal processing, whereby information can be reproduced.

However in the case of prior art that makes the sizes of the recording marks and spaces shorter in order to implement higher density recording, a number of recording marks and spaces shorter than the diffraction limit increases. In this case, it becomes even more difficult to determine the lengths of the recording marks and spaces, and reproduced signal processing becomes complicated, which increases circuit scale.

Therefore as a method that is different from the conventionally used mark edge recording method for recording information on an optical disk as binary data, a multi-valued recording method for recording multi-valued recording information has been proposed.

Examples of prior art related to the multi-valued recording method are disclosed in Patent Literature 1 and Patent Literature 2.

According to the multi-valued recording method of Patent Literature 1, information is recorded by forming a concave/convex pattern on a master optical disk, corresponding to three or more values of data of which pit depths are different, and corresponding to three or more values of data acquired by moving the pit positions in the diameter direction.

According to the multi-valued recording method of Patent Literature 2, a laser beam is irradiated onto the pits formed on a recording layer, and information is recorded by resolving the recording layer. Multi-valued information is recorded at this time by adjusting the output of the laser beam.

Multi-valued information is recorded on the information recording medium according to Patent Literature 1 by changing the depth of the pits at multiple levels. To form pits according to Patent Literature 1, a concave/convex pattern is formed on a resist substrate, a stamper is created using the resist substrate, and the stamper is transferred to the disk substrate of the information recording medium, so as to form the concave/convex pattern on the disk substrate. Then a reflection film, a recording film, a dielectric film or the like is layered on the disk substrate, whereby the information recording medium is fabricated.

A characteristic of Patent Literature 1 is that information is recorded by moving the position of the pits in the diameter direction. In the case of recording information on an information recording medium by a laser beam, the position of the laser beam must be accurately controlled at high-speed in pit period units. This control however is very difficult for an operation of a device.

As the above two aspects indicate, multi-valued recording on the information recording medium according to Patent Literature 1 is a technique for creating a master disk of an information recording medium used only for reproduction (ROM: Read Only Memory). Therefore a consumer, that is a general user, cannot freely record information on the information recording medium.

The information recording medium of Patent Literature 2 is an information recording medium where additional information can be recorded. In the information recording medium, the reflectance or refractive index of the recording layer is changed not only by a change in the reflected light quantity depending on whether a pit exists or not, but also by recording information in the pits. As a result, the reflected light quantity of the pits changes at multiple levels, whereby multi-valued information is recorded. Since information is recorded in the pits of the information recording medium, heat does not spread very much. In particular, the spread of heat to adjacent pit strings can be suppressed.

However the intervals of the pits (hereafter pit period) in Patent Literature 2 is constant based on the angular velocity. Therefore a length of a pit and a length between pits (hereafter space), which is a portion that is not a pit, in an outer circumference are set to be longer than those in an inner circumference. A recording density decreases if a length of a pit becomes longer, since multi-valued recording is performed by changing the reflected light quantity of a pit at multiple levels.

A recording density also decreases if the recording area is divided into a plurality of sectors, and a pit period at the beginning of each sector is the same as a pit period at the innermost circumference, since the pit period is based on the angular velocity. Furthermore, in this case, a new recording adjustment means, such as changing time to be recorded in a pit or rotation frequency of the angular velocity, is required when sectors are switched.

Even if the pit period is set to be constant based on linear velocity, the pit period disperses depending on the information recording medium during the processing of manufacturing the information media. The influence of the dispersion of the pit period in particular increases if the pit period is decreased by making the lengths of the pit and space short, in order to increase recording density.

Therefore if the time of the recording unit in the multi-valued recording is simply fixed and information is recorded without considering dispersion of the pit period, information is recorded as shifted from the pit period. In this case, recording in the pits cannot be executed appropriately for a conventional information recording medium.

Because of these problems, in the information recording medium to record multi-values using pits, the multi-valued recording method for changing the depth of the pits is mainly used for recording information on information recording medium used only for reproduction. In this case, however, a problem is that a general user cannot record information.

An available technique to perform multi-valued recording on a recording type information recording medium using pits combines the presence of pits and the change of reflectance or refractive index of the recording film. However a problem here is that multi-valued recording does not sufficiently consider the pit period, and recording in the pits cannot be executed appropriately.

### CITATION LIST

### Patent Literature

Patent Literature 1: Japanese Patent Application Laid-Open No. 2006-24299
Patent Literature 2: Japanese Patent Application Laid-Open No. 2007-317341

### SUMMARY OF THE INVENTION

With the foregoing in view, it is an object of the present invention to provide an information recording medium, an information recording method and an information recording apparatus that allow recording information at high-density and recording information stably.

An information recording medium according to an aspect of the present invention is an information recording medium having a plurality of pits which are formed periodically, wherein information is recorded by irradiating a laser bean onto a pit string constituted by the plurality of pits, and changing the shape of the pits, the pit string periodically wobbles, a length of a period of the pits is a diffraction limit of the laser beam or less, and the period of the pit string is n times (n is a positive integer) of the period of the pits.

According to this configuration, a pit string constituted by the plurality of pits periodically wobbles, a length of a period of the pits is the diffraction limit of the laser beam or less, and the period of the pit string is n times (n is a positive integer) of the period of the pits.

According to this invention, the length of the period of the pits is the diffraction limit of the laser beam or less, hence information can be recorded in short recording units, and information can be recorded at high density. Since the pit string periodically wobbles and the period of the pit string is n times (n is a positive integer) of the period of the pits, accurate timing information to record information in the pits can be acquired from the period of the pit string when the period of the pits is shorter than the optical resolution, and information can be recorded stably.

The objects, features and advantages of the present invention will become more apparent upon reading the following detailed description along with the accompanying drawings.

### BRIEF DESCRIPTION OF THE DRAWINGS

FIG. 1 is a diagram depicting an information recording medium according to this embodiment.

FIG. 2 is a schematic diagram depicting a structure of a data area of the information recording medium according to this embodiment.

FIG. 3 is a diagram depicting arrangement of pits according to this embodiment.

FIG. 4 is a diagram depicting wobbling of pit strings according to this embodiment.

FIG. 5 is a diagram depicting a relationship of a pit period and wobble period.

FIG. 6 is a cross-sectional view depicting a pit before recording according to this embodiment.

FIG. 7 is a cross-sectional view depicting the pit after recording according to this embodiment.

FIG. 8 is a diagram depicting a reproduced signal acquired when recording conditions are changed for a pit string.

FIG. 9 is a diagram depicting a reproduced signal acquired by irradiating a laser beam onto an unrecorded pit string.

FIG. 10 is a diagram depicting a reproduced signal acquired by irradiating a laser beam onto a recorded pit string.

FIG. 11 is a diagram depicting a relationship of a recording power and an amplitude change ratio.

FIG. 12 is a diagram depicting a relationship of a set value of the recording power in the multi-valued recording and an amplitude change ratio.

FIG. 13 is a diagram depicting a pit string and a reproduced signal when the pit period is longer than the diffraction limit.

FIG. 14 is a diagram depicting a pit string and a reproduced signal when the pit period is longer than the diffraction limit and shorter than the pit period shown in FIG. 13.

FIG. 15 is a diagram depicting a pit string and a reproduced signal when the pit period is shorter than the diffraction limit.

FIG. 16 is a diagram depicting a reproduced signal acquired when recording conditions are changed for the pit string which length of the pit period is the diffraction limit or less.

FIG. 17 is a diagram depicting a change of the signal level of the reproduced signal.

FIG. 18 is a diagram depicting a relationship between a recording power and a signal level change ratio.

FIG. 19 is a diagram depicting a relationship between a recording block and a recording clock according to this embodiment.

FIG. 20 is a block diagram depicting a configuration of the information recording apparatus according to this embodiment.

FIG. 21 is a block diagram depicting a configuration of the information recording/reproducing apparatus according to this embodiment.

### DESCRIPTION OF EMBODIMENTS

Embodiments of the present invention will now be described with reference to the drawings. The same composing elements are denoted with a same reference symbol, where redundant description is omitted. The following embodiments are merely examples for carrying out the invention, and are not intended to limit the technical scope of the invention.

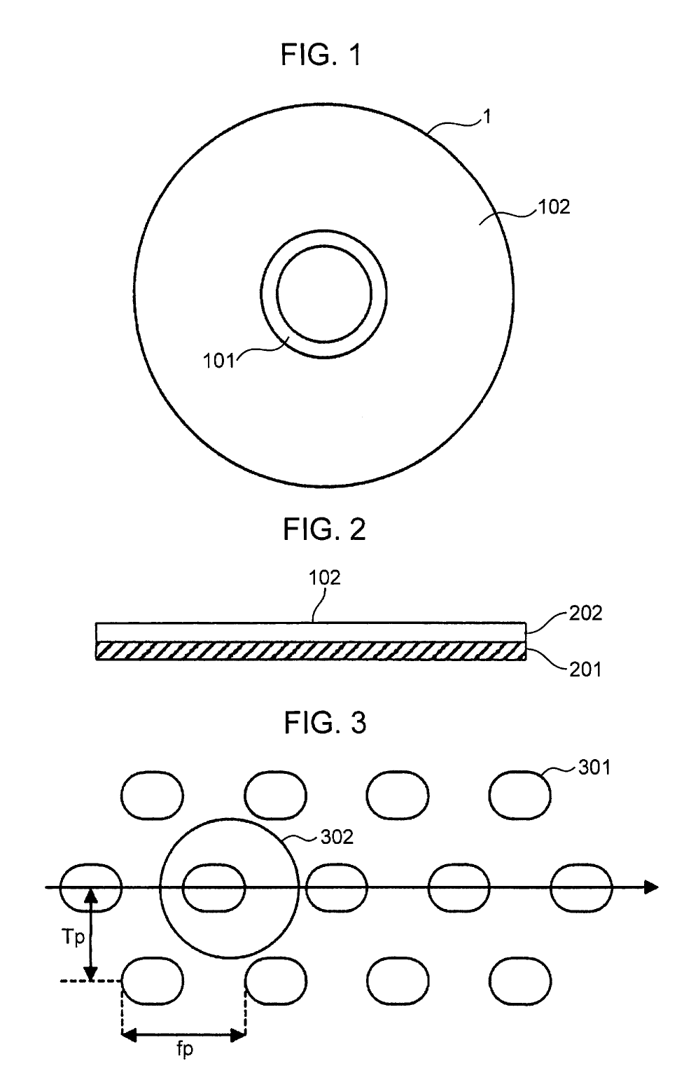

First an information recording medium according to this embodiment will be described. FIG. 1 is a diagram depicting an information recording medium according to this embodiment.

In FIG. 1, information recording medium 1 is an information recording medium where information is optically recorded or reproduced, and is an optical disk, for example.

The information recording medium 1 has an information area 101 and a data area 102. The information area 101 is an area where media information on the information recording medium 1, such as recording conditions, is recorded. The data area 102 is an area for recording data information. In FIG. 1, the information area 101 is located in the inner circumference side of the data area 102, but may be located in the outer circumference side of the data area 102.

Now the structure of the data area 102 of the information recording medium 1 will be described. FIG. 2 is a schematic diagram depicting a structure of the data area of the information recording medium according to this embodiment.

The data area 102 has a substrate 201 and a recording layer 202. The substrate 201 is composed of polycarbonate resin, for example, and a recording film of the recording layer 202 is comprised of a phase change material or an organic dye film, for example.

The substrate 201 of the information recording medium 1 has concave or convex pits. The recording layer 202 is laminated on the substrate 201. In order to protect the recording layer 202, a cover layer composed of UV-curable resin or the like may be laminated on the recording layer 202.

FIG. 3 is a diagram depicting the arrangement of pits according to this embodiment. In FIG. 3, a plurality of pits 301 is arranged at a predetermined period fp along the traveling direction of a spot 302 of a laser beam, whereby a pit string is formed. The information recording medium 1 has a plurality of pits 301 which is periodically formed, and information is recorded therein by irradiating a laser beam onto a pit string constituted by the plurality of pits 301, and changing the form of the pits 301. The form of the pits 301 changes corresponding to information in binary or more.

The pit string is formed with a predetermined pitch interval Tp from an adjacent pit string. Here the spread of heat to adjacent pit strings during recording can be suppressed by shifting the center position of each pit by half of the period fp with respect to the adjacent pit strings.

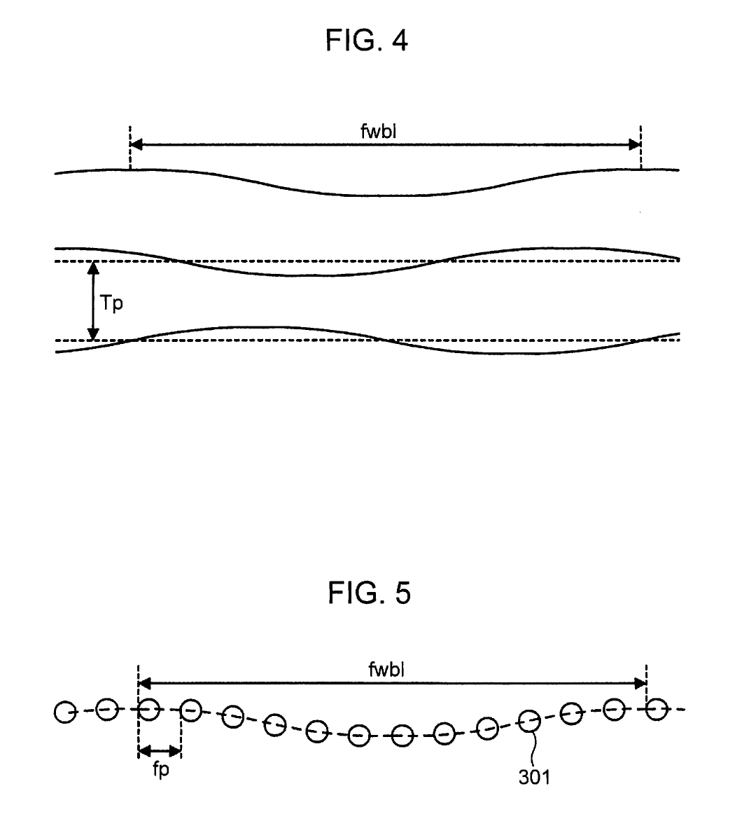

A pit string is formed in a spiral or concentrically on the information recording medium 1, and periodically wobbles based on the control by a wobble signal. The wobbling of the pit string will be described with reference to FIG. 4. FIG. 4 is a diagram depicting the wobbling of pit strings according to this embodiment.

As FIG. 4 shows, each pit string wobbles at a predetermined period (hereafter wobble period) fwbl.

Wobbling of a pit string is formed based on the control by a wobble signal, and the pit string is displaced in the diameter direction from the center of the pit string. A phase of the wobble period is not always the same as an adjacent pit string. The amount of displacement in the diameter direction is sufficiently smaller than the pitch interval Tp.

In this embodiment, it is preferable that the address information of the information recording medium is recorded utilizing the wobbling of the pit string. The address information of the information recording medium is recorded by modulation performed by the wobbling of the pit string.

The address information is recorded by modulation of a wobble signal. Modulation of a wobble signal is, for example, frequency modulation in which the frequency of the wobble period is modulated, phase modulation in which the phase of the wobble period is modulated, or amplitude modulation in which amplitude of the wobble signal is modulated. A method for recording address information using a wobble signal and the format configuration of the address information can be implemented by the technique that is used for DVDs or BDs, hence description is omitted in this embodiment.

A conventional information recording medium has a land/groove structure where the groove portion wobbles. However, the information recording medium according to this embodiment has no groove portion. Since wobbling of the pit string is used, address information can be detected from the pit string even if the information recording medium is in an unrecorded state, where information (including address information) is not recorded in the recording area.

If the format configuration of the address information of this embodiment is the same as the format configuration of the address information of prior art, the wobble detection circuit and the address detection circuit of the prior art can be used. In other words, the information recording/reproducing apparatus used for a conventional information recording medium can detect address information of the information recording medium 1 of this embodiment, without adding a new circuit for detecting address information.

It is preferable that the wobble period fwbl of the pit string is n times (n is a positive integer) of the pit period fp.

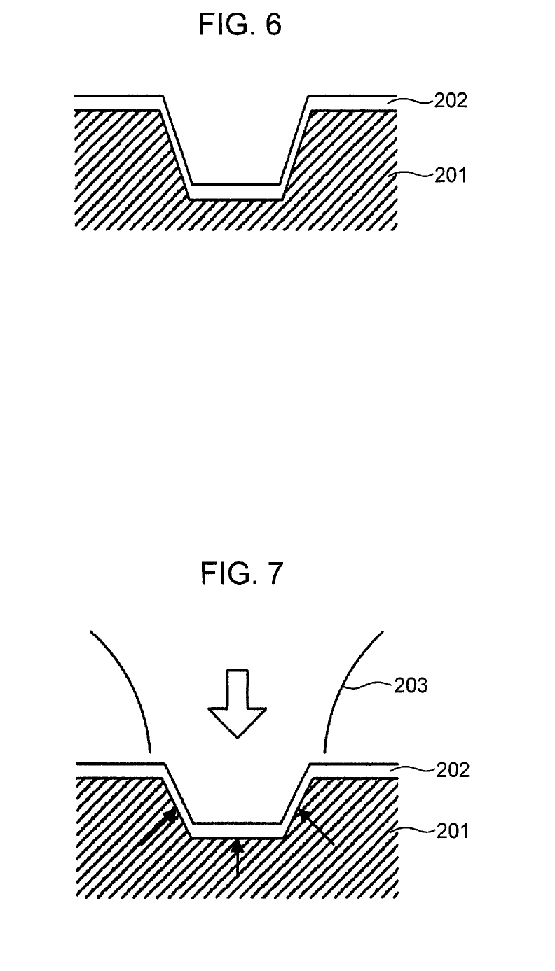

FIG. 5 is a diagram depicting the relationship between the pit period and the wobble period according to this embodiment. FIG. 5 shows a pit string where a plurality of pits 301 are arranged at the pit period fp. The pit string wobbles at the wobble period fwbl. In this case, the wobble period fwbl is set to n times (n is a positive integer) of the pit period fp. In the case of FIG. 5, the wobble period fwbl is 12 times of the pit period fp, that is n=12. This embodiment, however, is not limited to n=12. It is preferable that n is 2 or greater integer.

By multiplying the frequency of a signal which detected the wobble period, a clock matching the pit period can be generated. The clock can be used as a recording clock during a recording operation for recording information on an information recording medium, or as a reproducing clock during a reproduction operation for reproducing information. This configuration generates a superb effect when the pit period fp is shorter than the optical resolution of the optical beam for recording or reproducing information. To record data at high density, the shorter the pit period fp the better. However, if the pit period fp is shorter than the optical resolution of the optical beam, in some cases a timing signal for accurately irradiating a recording power onto the pits cannot be received.

However, in the information recording medium of this embodiment, the period of wobbling a pit string is a predetermined multiple of the period of successive pits, as shown in FIG. 5. Therefore the information recording apparatus can acquire accurate timing information to record information in the pits based on the period information of the wobbled groove. A concrete method for recording information in the pits will be described in detail later.

Furthermore, even if the pit period disperses depending on each information recording medium or within an information recording medium during the manufacturing process of the information recording media, a clock corresponding to the dispersion of the pit period can be generated by detecting the wobble period fwbl.

In multi-valued recording according to this embodiment, the recording unit time in the multi-valued recording is controlled by the generated-clock. Thereby a number of pits that appear in the recording unit time can be set to a same condition, and recording or reproducing dispersion for the pits can be suppressed.

In this embodiment however, it is not always necessary to use a recording clock or reproducing clock that matches with the pit period. For example, it is preferable that the recording clock or reproducing clock is shorter in time than the pit period. In this case, a recording operation for the spaces is not required, and the conduction of heat generated by recording in the pits can be suppressed. When recording information in the pits, a recording pulse shape suitable for the information recording medium can be set.

The recording unit according to this embodiment is a unit of recording information generated by converting a digital signal, which is recording data, into multi-valued information.

For example, if a digital signal has 16 bits, “1100111100010110”, and is recorded at a 4-bit recording unit, then the recording of this digital signal is executed in four sections (1100, 1111, 0001, 0110). In this case, each 4-bit data, which is the recording unit, is a multi-valued pattern, and a multi-valued level according to the multi-valued pattern is recorded on the information recording medium.

Description on recording at a multi-value level on the information recording medium, which is described later with reference to FIG. 12, is omitted here. The recording unit used in FIG. 12 is a 3-bit recording unit.

The recording block according to this embodiment is a physical length of the recording unit. Since the time required for the recording unit can be calculated based on the physical length and rotation speed of the information recording medium, the recording block can also be handled as a time required for the recording unit. Therefore the time required for the recording unit according to this embodiment is the recording block when handled as time.

Now recording information on the pits will be described. A cross-section of a pit and a transformation of the pit will be described with reference to FIG. 6 and FIG. 7.

FIG. 6 is a cross-sectional view depicting a pit before recording according to this embodiment, and FIG. 7 is a cross-sectional view depicting the pit after recording according to this embodiment.

In FIG. 6, the cross-sectional profile of the pit is trapezoidal. The cross-sectional profile of the pit of this embodiment is not limited to trapezoidal, but may be rectangular, V-shaped or U-shaped or the like.

As FIG. 6 shows, a pit is formed on the substrate 201 to be concave with respect to the laser beam irradiation direction, and the recording layer 202 is laminated on the substrate 201. The substrate 201 may have a convex form instead of a concave form.

In the information recording medium 1 according to this embodiment, a laser beam is irradiated from the recording layer 202 side, and information is recorded or reproduced.

When information is recorded, a laser beam 203 having higher power than reproduction is irradiated onto the pit in FIG. 6, whereby the shape of the pit is changed to that shown in FIG. 7.

This is because the thermal energy of the laser beam is stored in the recording layer 202 in the pit, and the substrate 201 is transformed by this heat. Since the quantity of the heat that is transferred to the substrate 201 increases as the recording layer 202 becomes thinner, the shape of the pit can be changed by a lower recording power.

Therefore in this embodiment, it is preferable not to create a protection layer, which suppresses a change in the shape of a pit, between the substrate 201 and the recording layer 202 of the information recording medium 1. However, a layer having a medium of which transformation by heat is greater than the substrate 201, or a layer which promotes the transformation of the substrate 201, may be disposed between the substrate 201 and the recording layer 202.

The optical characteristics, such as reflectance and transmittance, of the recording layer 202 are also changed by the laser beam 203. But the change of the reflected light quantity by the change of the shape of the pit is greater than the change of the optical characteristics. In other words, according to this embodiment, information is recorded not by using the change of the optical characteristics of the recording layer 202, but by using the change of the shape of the pits. The multi-valued recording in this embodiment is recorded in the pits since the shape of the pits is changed, but if the change of the optical characteristics is minimal, information may be recorded in recording units, including both pits and spaces.

In this embodiment, description on the change of the optical characteristics is omitted unless absolutely necessary.

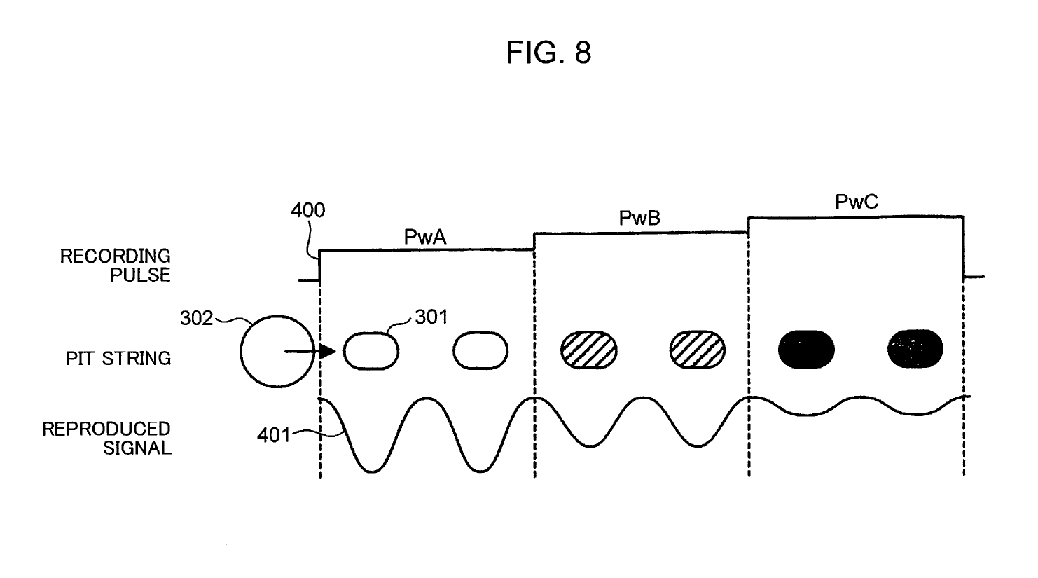

FIG. 8 is a diagram depicting a reproduced signal acquired when the recording conditions are changed for the pit string.

In FIG. 8, the recording pulse 400 indicates a recording power of a laser beam that is irradiated onto the pits and spaces. In FIG. 8, the recording pulse 400 has a shape for performing DC emission, but may have other recording pulse shapes, such as a multi-pulse shape and a castle shape, which are not illustrated. The recording power is changed in three levels (PwA, PwB, PwC) here. The intensity values of the recording power are PwA<PwB<PwC. The recording block of each recording power is the recording unit for multi-valued recording.

In FIG. 8, a pit string constituted by the transformed pits 301 is reproduced by the spot 302 of the laser beam. Here the pits 301 are periodically arranged. The length of the pit and the length of the space are the same in FIG. 8, but the ratio of the length of the pit and the length of the space may be different from this example. The degree of transformation of the pit 301 is different depending on the recording power of the recording pulse 400 in FIG. 8. As the recording power becomes higher, the shape of the pits changes even more. In FIG. 8, the change of the shape of the pit is small when the recording power is PwA, and the change of the shape of the pit is large when the recording power is high, PwC.

The reproduced signal 401 is a reproduced signal that is detected when the pit string in FIG. 8 is reproduced. The amplitude of the reproduced signal 401 is different depending on the change of the shape of the pit in FIG. 8. This is because the amplitude of the reproduced signal 401 changes as the reflected light amount changes due to the change of the shape of the pit. Therefore the amplitude of the reproduced signal 401 is high in the recording block of the recording power PwA where the change of the shape of the pit is small, and the amplitude of the reproduced signal 401 is low in the recording block of the recording power PwC where the change of the shape of the pit is large.

Now multi-valued recording using the change of the shape of the pit will be described.

First the detection of the ratio of the change of the amplitude of the reproduced signal, with respect to the change of the shape of the pit (hereafter called “amplitude change ratio”), will be described.

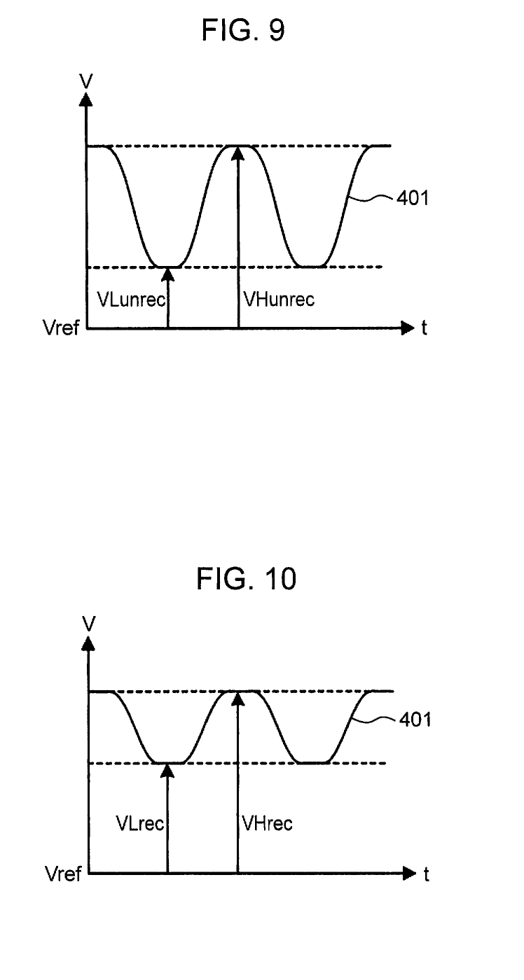

The amplitude change ratio of the reproduced signal will be described with reference to FIG. 9 and FIG. 10.

FIG. 9 is a diagram depicting a reproduced signal acquired by irradiating a laser beam onto an unrecorded pit string. FIG. 10 is a diagram depicting a reproduced signal acquired by irradiating a laser beam onto a recorded pit string. In FIG. 9 and FIG. 10, the abscissa indicates time t, and the ordinate indicates voltage V.

Vref is a voltage when a reproduced signal 401 is not detected, and is a reference level to detect a signal level of a reproduced signal 401.

In the reproduced signal 401 in FIG. 9, the signal level VHunrec is a maximum value from the reference level Vref, and the signal level VLunrec is a minimum value from the reference level Vref.

In the reproduced signal 401 in FIG. 10, the signal level VHrec is the maximum value from the reference level Vref, and the signal level VLrec is the minimum value from the reference level Vref.

The amplitude change ratio of the reproduced signal according to this embodiment indicates how much the amplitude of the reproduced signal on the recorded pit string has changed from the amplitude of the reproduced signal on the unrecorded pit string as a reference. Therefore the amplitude change ratio m is calculated by the following Expression (1).

m=1−(VHrec−VLrec)/(VHunrec−VLunrec) (1)

As Expression (1) shows, as the amplitude of the reproduced signal on the recorded pit string decreases by recording information, the amplitude change ratio m increases.

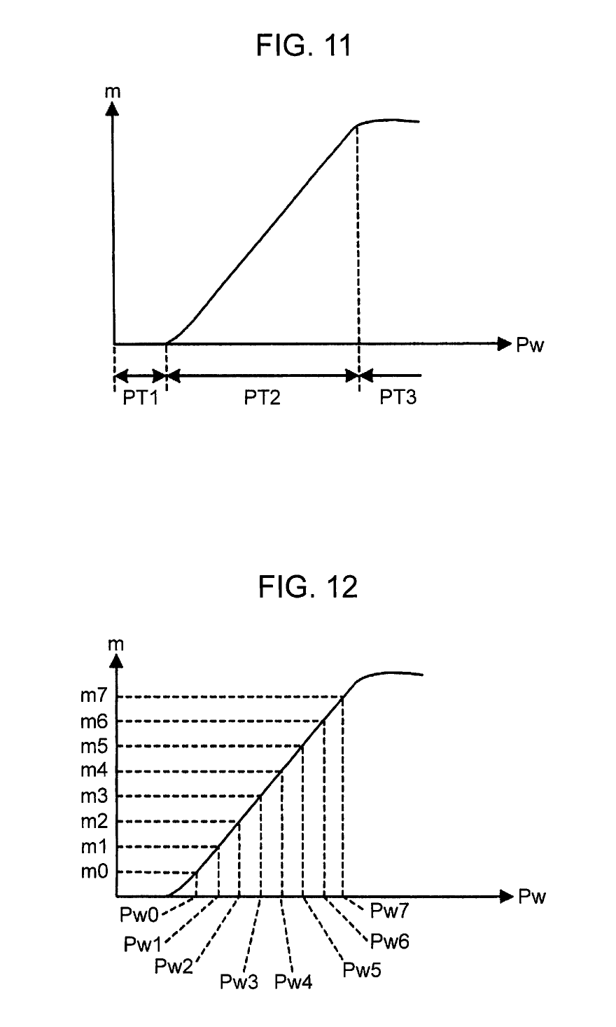

FIG. 11 is a diagram depicting the relationship of the recording power Pw and the amplitude change ratio m. In FIG. 11, characteristics of the amplitude change ratio m is classified into three recording power ranges: PT1, PT2 and PT3. Depending on the configuration of the information recording medium, the recording power range PT3 may not exist.

In the recording power range PT1, the shape of the pit does not change since the recording power is low. In the recording power range PT2, the shape of the pits changes, and the amplification change ratio m linearly changes with respect to the change of the recording power. In the recording power range PT3, the change of the shape of the pit reaches the highest limit, and the amplification change ratio m becomes approximately constant.

In the case of multi-valued recording according to this embodiment, the recording power range PT2 is used, where the shape of the pits changes, and the amplification change ratio m changes as the recording power changes.

FIG. 12 is a diagram depicting the relationship between the setting value of the recording power and amplification change ratio m in the multi-valued recording. Here the multi-valued level of the multi-valued recording is three values or more in eight levels (3-bit), but the present invention is not limited to this.

As FIG. 12 shows, in the recording power range PT2, the change of each recording power (Pw0, Pw1, . . . , Pw7) for recording, with respect to each amplification change ratio (m0, m1, . . . , m7) is constant. This is because the amplitude change ratio m linearly changes with respect to the change of the recording power Pw.

According to the multi-valued recording of this embodiment, a recording power that corresponds to the multi-valued level is set, and information is recorded at the recording power that is set, and the shape of the pit is changed accordingly. For the reproduction of information recorded by the multi-valued recording as well, a signal that corresponds to the multi-valued level can be detected by detecting the amplitude change ratio m.

In this embodiment, a signal that corresponds to the multi-valued level is detected by detecting the amplitude change ratio m, that is, a ratio of the change of the amplitude of the reproduced signal with respect to the change of the shape of the pit, but the present invention is not limited to this. For example, a signal that corresponds to the multi-valued level may be detected using another index, such as the modulation degree.

In this embodiment, the amplitude change ratio m of the reproduced signal changes linearly with respect to the change of the recording power. However if the amplitude change ratio m of the reproduced signal changes nonlinearly with respect to the change of the recording power, due to the change of optical characteristics, for example, amplitude change ratios m are set with equal intervals, and recording power is set for each amplitude change ratio m. Then the detection window of the amplitude change ratio m can be widely set. In this case, it is preferable that the recording power range PT2 is used for the setting range of the recording power.

In the above description, the recording power of DC emission is changed in order to change the amplitude of the reproduced signal, but the recording power of a different recording pulse shape may be changed, or the pulse width may be changed. The recording state at the recording power Pw0 is equivalent to the unrecorded state. Therefore for the recording power Pw0, the recording power range PT1, which is a state where the reproduced signal is not recorded, may be used.

In this way, according to the multi-valued recording method of this embodiment, the amplitude level of the reproduced signal is changed by recording information on the periodically arranged pit string with changing the recording conditions (e.g. recording power, pulse width).

In FIG. 8, in multi-valued recording, the pit period fp is set to be long in order to describe the amplitude change of the reproduced signal.

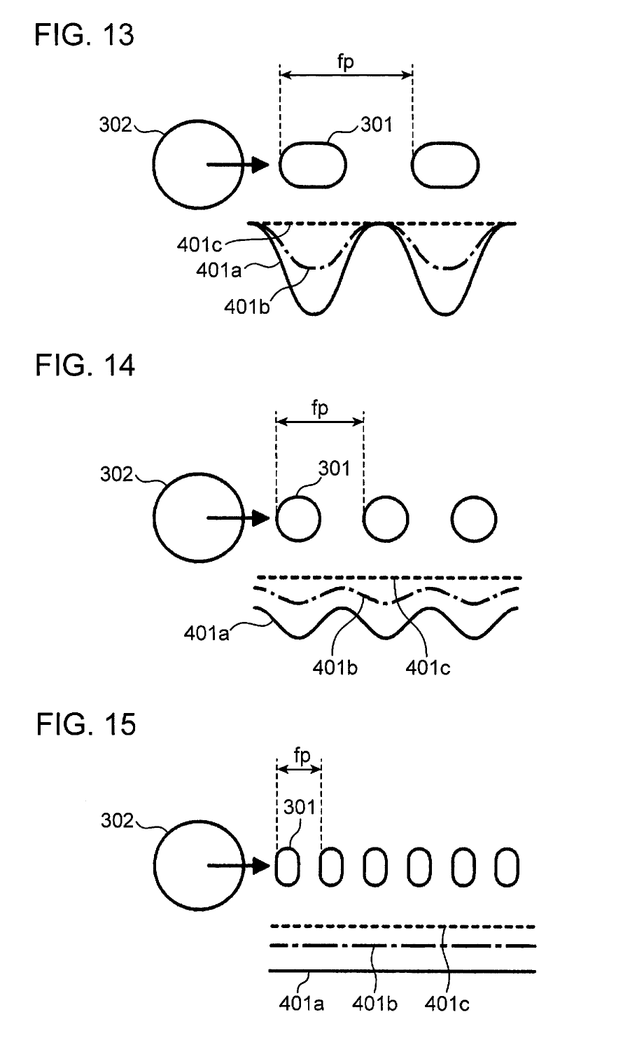

Now a reproduced signal when the pit period fp is set to be short in this embodiment will be described. The reproduced signal when the pit period fp is changed will be described with reference to FIG. 13, FIG. 14 and FIG. 15.

A pit 301 in FIG. 13, FIG. 14 and FIG. 15 is a part of a pit string. In FIG. 13, FIG. 14 and FIG. 15, a reproduced signal 401a indicated by a solid line is a reproduced signal when the pits are not recorded, a reproduced signal 401b indicated by a dashed line is a reproduced signal when the pits are transformed slightly by irradiation of a laser beam having a low recording power, and a reproduced signal 401c indicated by a dotted line is a reproduced signal when the pits are transformed by irradiation of a laser beam having a high recording power, and the reflected light quantity of a pit becomes the same as the reflected light quantity of a space.

FIG. 13 is a diagram depicting a pit string and a reproduced signal when the pit period fp is longer than the diffraction limit. As described in FIG. 8, the period of the pits 301 appears in the reproduced signals 401a, 401b and 401c. If the pit 301 is transformed by irradiation of a recording power, the signal intensity changes in the pit 301 portion. The signal intensity does not change in the space portion.

FIG. 14 is a diagram depicting a pit string and a reproduced signal when the pit period fp is longer than the diffraction limit, and is shorter than the pit period fp shown in FIG. 13. The period of the pits 301 appears in the reproduced signals 401a, 401b and 401c, but the amplitudes of the reproduced signals 401a, 401b and 401c decreases since optical resolution decreases. The signal level in the pit 301 increases, whereas the signal level in the space portion between the pits 301 decreases. If a laser beam is irradiated and information is recorded in the pits 301, the reproduced signal changes because the pits 301 are transformed. In this case, the signal level in the space between the pits 301 changes simultaneously with the signal level in the pit 301. The signal level in the space between the pits 301 changes because the pit period fp is so short that optical resolution decreases, and the signal level in the space receives optical interference from the pit 301 portion.

FIG. 15 is a diagram depicting the pit string and reproduced signal when the pit period fp is shorter than the diffraction limit.

In FIG. 15, the period of the pits 301 does not appear in the reproduced signals 401a, 401b and 401c since the pit period fp is shorter than the diffraction limit. However, if a laser beam is irradiated onto the pits 301 and the pits 301 transform, the level of the reproduced signal can be successively changed.

In FIG. 13 and FIG. 14, in order to detect the amplitude change ratio, it is necessary to detect the peak values of the upper envelope (VHunrec in FIG. 9, and VHrec in FIG. 10), and the lower envelope (VLunrec in FIG. 9, and VLrec in FIG. 10) of the reproduced signal. In terms of accuracy and speed of detection, selecting a pit period with which reproduced signals that correspond to the pits do not appear as shown in FIG. 15 is most appropriate.

In the case of FIG. 13, FIG. 14 and FIG. 15, the duty of the pit 301 and the space between pits is 50%, that is 1:1, but the present invention is not limited to this. If the space between adjacent pits is decreased, the level of the reproduced signal decreases. If information is recorded in the pit 301 and the transforming force of the pit 301 is increased, the pit portion may disappear. In such a case, a greater signal change can be acquired if the space between adjacent pits is narrower than the pit length.

As mentioned above, if the length of the pit period fp is set to the diffraction limit or less, multi-valued recording that allows accurately detecting a signal can be implemented. Therefore it is preferable that the length of the pit period fp in this embodiment is the diffraction limit or less.

The length of the pit period fp becomes the diffraction limit or less if the pit period fp satisfies the conditions of the following Expression (2).

fp≦λ(2×NA) (2)

Here λ denotes a wavelength of the laser beam, and NA denotes a numerical aperture of the objective lens. An information recording medium of which pit period fp satisfies Expression (2) has short pits and spaces, of which length is the diffraction limit or less. For example, in the case of a standard BD system, the pit period fp is approximately 238.2 nm or less, since λ=405 nm and NA=0.85.

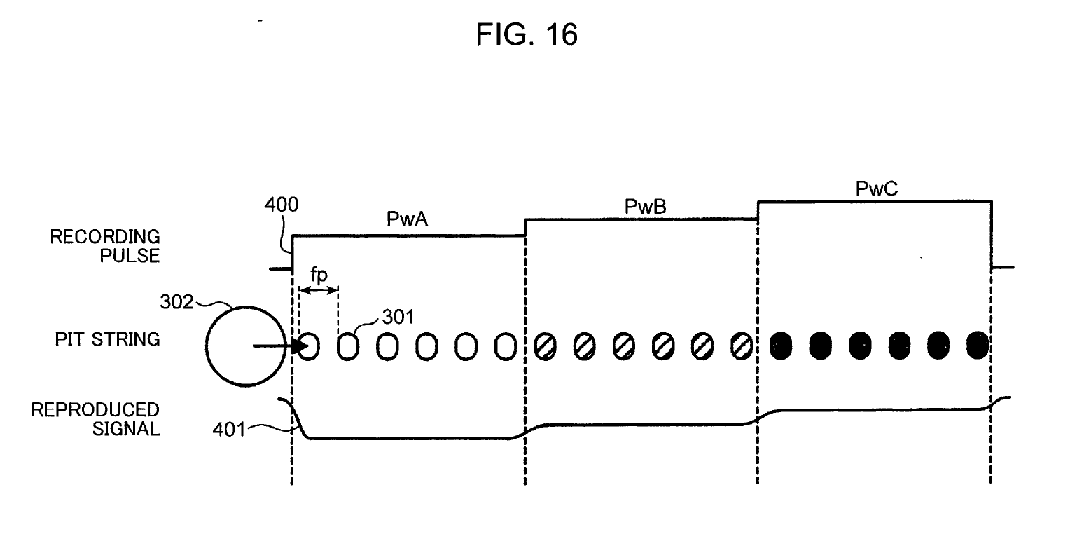

FIG. 16 is a diagram depicting a reproduced signal that is acquired when the recording conditions are changed for a pit string of which length of the pit period is the diffraction limit or less.

The length of the pit period fp of the pit string in FIG. 16 is set to the diffraction limit or less, unlike the pit string in FIG. 8.

The recording pulse 400 in FIG. 16 is generated with changing the recording conditions. Here the recording power of DC emission is changed at three levels (PwA, PwB, PwC) in the same manner as FIG. 8.

In FIG. 16, a pit string constituted by transformed pits 301 is reproduced by the spot 302 of the laser beam. In this case, the pits 301 are periodically arranged, and the length of the pit period fp is the diffraction limit or less.

The reproduced signal 401 is a reproduced signal that is detected when the pit string in FIG. 16 is reproduced. If a pit string, of which length of the pit period fp is the diffraction limit or less, is generated, the amplitude of the reproduced signal 401 becomes virtually zero. Therefore the reproduced signal 401 has a signal level that has no amplitude. The reproduced signal 401 is detected based on the reflected light quantity values from both the pits and spaces, and the signal level of the reproduced signal 401 becomes approximately constant. Since the reflected light quantity due to the change of the shape of the pit is different depending on the recording power, the signal level changes depending on the recording power, as shown in the reproduced signal 401 in FIG. 16.

The reproduced signal at a change point of the recording power (e.g. boundary between the recording power PwA and the recording power PwB) is detected based on the pits recorded with the recording power before the change point and the recording power after the change point. Therefore the signal level of the reproduced signal 401 changes in FIG. 16. This means that, in order to appropriately detect the signal level of the reproduced signal 401, it is desirable to use a recording range excluding the area near the change point of the recording conditions, that is, the recording range in which signal level is approximately constant.

As mentioned above, if the length of the pit period fp of the pit string is the diffraction limit or less, the reproduced signal has a constant signal level, hence the signal level is detected without detecting the peak value. In this case, the signal level is approximately constant, so a number of times of detecting the signal level is more than a number of times of detecting the peak value of a reproduced signal having an amplitude. In other words, the signal level can be accurately detected. To detect the peak values, both the upper envelope and the lower envelope of the reproduced signal must be detected. To detect the signal level, however, it is sufficient to detect only the level value, and circuit scale can be reduced.

Furthermore, if the length of the pit period fp of the pit string is the diffraction limit or less, the frequency of the pit period fp shifts to a higher frequency side of the wobble frequency band, which is set in a low frequency area, and the amplitude of the signal of the pit period fp is not detected. As a result, the reproduced signal according to this embodiment becomes approximately the same as the reproduced signal when the wobbling groove portion is reproduced in the conventional information recording medium. In other words, the conventional address detection method, for detecting address information in an information recording medium where address information is recorded using the wobble signal, can be applied.

In FIG. 16, the recording block is set to be long in order to describe the change of the signal level of the reproduced signal, but it is preferable to set the recording block to be a time unit, with which the change of the signal level of the reproduced signal can be detected. In this case, the recording density can be increased, since the multi-valued recording can be performed in short recording units.

If the appearance pattern of the multi-valued levels is limited so that the signal level of the pit of which length is the diffraction limit or less can be detected, it is preferable that the recording block is set to the unit of the pit length. Thereby the recording density can be further increased.

Now how to detect a ratio of the change of the signal level (hereafter signal level change ratio) in the multi-valued recording of the information recording medium, when the length of the pit period fp of the pit string is the diffraction limit or less, will be described.

In the case of detecting the amplitude change ratio described above, a reproduced signal has an amplitude in the unrecorded pit string, and the amplitude of the reproduced signal decreases due to the multi-valued recording. Therefore a ratio of the change of the amplitude of the reproduced signal due to the multi-valued recording, from the amplitude of the reproduced signal in the unrecorded pit string as the maximum value, is detected.

In the case of detecting the signal level, however, the reproduced signal is at the signal level for both the unrecorded pit string and the pit string after the multi-valued recording is performed. Therefore a maximum value of the signal level must be set. For the maximum value of the signal level in this embodiment, a signal level Vo when an area not having a pit is reproduced, or a signal level Vm at which the signal level no longer changes by recording, is set.

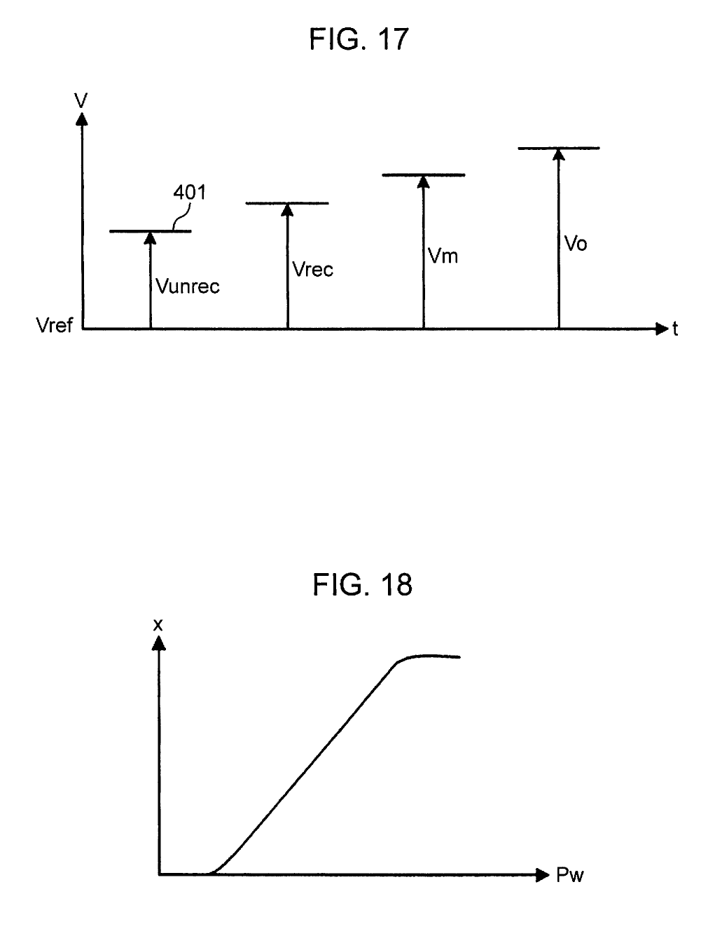

Now the change of the signal level of the reproduced signal will be described with reference to FIG. 17. FIG. 17 is a diagram for depicting the change of the signal level of the reproduced signal. In FIG. 17, the abscissa indicates time t, and the ordinate indicates voltage V.

Vref is voltage when the reproduced signal is not detected, and is a reference level when the signal level of the reproduced signal is detected.

The signal level Vunrec is a signal level of the reproduced signal in an unrecorded pit string. The signal level Vrec is a signal level of the reproduced signal in a pit string after multi-valued recording is performed. The signal level Vm is a signal level of the reproduced signal in a pit string of which change of the shape of the pits, due to recording, reached the upper limit. The signal level Vo is a signal level of the reproduced signal in an area where pits do not exist.

The signal level Vunrec corresponds to the unrecorded pits in the pit string, hence reflected light quantity is low. The signal level Vrec corresponds to the recorded pits in the pit string, hence reflected light quantity increases as the shape of the pits changes due to recording. The maximum signal level of the signal level Vm changes depending on the structure of the information recording medium, material of the recording film or the like, and can be the same level as the signal level Vo. The signal level Vm is also the upper limit of the signal level Vrec, since the change of the shape of the pits, due to recording, has reached the upper limit. The signal level Vo corresponds to an area where pits do not exist, hence the reflected light quantity is highest.

The relationship of the intensity of the signal levels is Vo≧Vm≧Vrec>Vunrec. In this embodiment, the reflected light quantity increases as the shape of the pits changes due to recording, but the reflected light quantity may decrease as the shape of the pits changes due to recording, but description thereof is omitted here since the same concept as the case of the reflected light quantity increasing can be applied.

To detect the signal level Vo, an area where only space exists and pits do not exist must be created in a part of the pit string, or in a predetermined area (e.g. innermost circumference area of the information recording medium), so that the area having only space is reproduced. The length of the area where only space exists is at least the length where pits are not included in the reproduction. The signal level of the reproduced signal, when the area having only space is reproduced, is the signal level Vo.

To detect the signal level Vm, an area having only space need not be set. The signal level that becomes maximum when the pit string after the multi-valued recording is performed is reproduced becomes the signal level Vm. However in order to prevent the fluctuation of the maximum level of the signal level due to the difference of recording conditions depending on the operation of the multi-valued recording, it is preferable that the recording conditions, for the signal level to become Vm in the multi-valued recording, are recording conditions that do not change the signal level. For example, the recording conditions are set so that the signal level becomes Vm in the recording power range PT3 in FIG. 11.

Therefore when the signal level Vo is detected, the signal level change ratio x is calculated by the following Expression (3).

x=1−(Vo−Vrec)/(Vo−Vunrec) (3)

In the same manner, when the signal level Vm is detected, the signal level change ratio x is calculated by the following Expression (4).

x=1−(Vm−Vrec)/(Vm−Vunrec) (4)

FIG. 18 is a diagram depicting the relationship of the recording power and the signal level change ratio. FIG. 18 shows a characteristic of the signal level change ratio x with respect to the recording power Pw, which is calculated based on the above mentioned Expression (3) and Expression (4). The numeric value (ordinate) of the signal level change ratio x which is detected based on Expression (3) is different from that which is detected based on Expression (4).

The characteristic between the recording power Pw and the signal level change ratio x in FIG. 18 is equivalent to the characteristic between the recording power Pw and the amplitude change ratio m described in FIG. 11. Therefore just like the relationship between the recording power setting and the amplitude change ratio in the multi-valued recording described in FIG. 12, the multi-valued recording is possible if the recording power is set with respect to the signal level change ratio x.

In this way, the multi-valued recording method according to this embodiment can also be applied to a pit string having a pit period fp of which length is the diffraction limit or less.

Now the relationship between wobble period fwbl, pit period fp and recording block L according to this embodiment will be described.

As mentioned above, the pit period fp of this embodiment is shorter than the optical resolution. In the case of a BD system, the length of the pit period fp is set to approximately 238.2 nm or less.

It is preferable that the length of the recording block L is set to be at least double the length of the pit period fp, which is the diffraction limit or less. This means that the recording block L has a length that allows reproducing at least one period of the length that is the diffraction limit or less. Thereby the recording range where the signal level is approximately constant can be detected more stably. Therefore the length of the recording block L is set to at least double of the pit period fp.

For example, in th case of a BD system, it is preferable that the length of the recording block L is set to approximately 476.5 nm or more. Then the recording information is recorded in the recording block L.

Here the state where the signal level change of the reproduced signal becomes maximum is the case when the recording block recorded with minimum recording power and the recording block recorded with maximum recording power are repeated. In other words, the length of one period of the signal level change of the reproduced signal is double of the recording block L.

The wobble signal is basically constituted only by fundamental frequency components. However up to the frequency band of the second harmonic wave may be used for the wobble signal when the wobble period is frequency-modulated, for example. Hence it is necessary to set so that the frequency component of the recording signal is not included in the second harmonic wave of the wobble signal. In other words, it is preferable that the length of the wobble period fwbl is set at least to double of one period of the signal level change of the reproduced signal.

Therefore it is preferable that the length of the wobble period fwbl is set to be four times of the recording block L or more. It is also preferable that the length of the wobble period fwbl is set to be eight times of the pit period fp or more.

If the optical system of a BD system is applied to the wobble period fwbl in this embodiment, the length of the wobble period fwbl is set to approximately 1.9 μm or more.

The length of the recording block L according to this embodiment need not be constant. For example, the multi-valued pattern may be set based on the combination of two parameters: the recording block L and the signal level of the reproduced signal at which the recording conditions are changed. If a multi-valued pattern has 4 bits (16 types), and this multi-valued pattern is separated into information on 2 bits (four types) of recording block L and information on 2 bits (four types) of the signal level, then the recording block Lmax having the longest length exists in the four types of the recording block L. The repeat of the recording block Lmax is the lowest frequency component. Therefore it is preferable that the length of the wobble period fwbl is set to four times of the recording block Lmax or more, for the same reason described above.

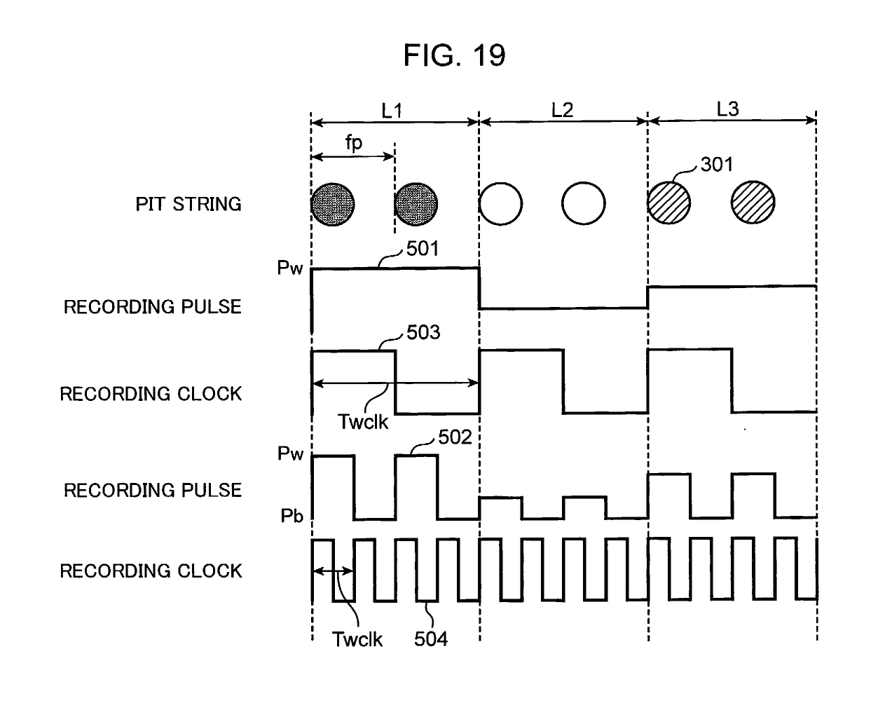

Now a relationship between the recording block and the recording clock will be described. FIG. 19 is a diagram depicting the relationship between the recording block and the recording clock according to this embodiment.

The pit string in FIG. 19 is constituted by a plurality of pits 301, and each recording block L1, l2 and L3 is recorded under different recording conditions.

The recording pulses 501 and 502 in FIG. 19 are examples of recording pulses generated when information is recorded in each recording block L1, L2 and L3.

A recording clock 503 in FIG. 19 is a recording clock for generating the recording pulse 501 in FIG. 19. A recording clock 504 in FIG. 19 is a recording clock for generating the recording pulse 502 in FIG. 19.

In FIG. 19, a laser beam is irradiated in each recording block L1, L2 and L3 under different recording conditions (recording power in this case) based on the recording pulse 501 or the recording pulse 502, therefore the shape of the pit 301 is different in each recording block L1, L2 and L3.

The recording pulse 501 in FIG. 19 is a recording pulse when the laser beam is irradiated at a same recording power Pw in one recording block. In other words, the recording pulse 501 is the same DC emission as the recording pulse 400 in FIG. 16. In this case, the shape of the pit is changed by changing the recording power Pw according to the multi-valued level.

The laser irradiation time in the recording block, that is the recording unit time, is the period Twclk of the recording clock 503, as shown in FIG. 19. The recording unit time in the multi-valued recording is set to an integral multiple of the recording clock 503, and the integral multiple of the recording clock 503 is 1.

In FIG. 19, the recording conditions are changed for each period Twclk of the recording block 503, but one period Twclk of the recording clock 503 may be set to be shorter, so that the recording conditions are changed in a plurality of periods of the recording clock. This is the same for the recording clock 504.

The recording pulse 502 in FIG. 19 is a multi-pulse having a high recording power Pw and a low recording power Pb in one recording block. The shape of the pits is changed by changing the recording power Pw according to the multi-valued level. Here the pulse period in the multi-pulse is set to be the same as the pit period fp.

In this case, the period Twclk of the recording clock 504 becomes ½ of the pit period fp, as shown in FIG. 19.

As mentioned above, the lengths of the recording blocks L1, L2 and L3 are set to be at least double of the pit period fp. Therefore the recording unit time in the multi-valued recording is set to be an integral multiple of the recording clock 504, and the integral multiple of the recording clock 504 is at least four times. In the example of FIG. 19, the recording blocks L1, L2 and L3 are set to be double of the pit period fp, and the pit period fp is set to be double of the period Twclk of the recording clock 504. In this case, the integral multiple of the recording clock 504 is four times.

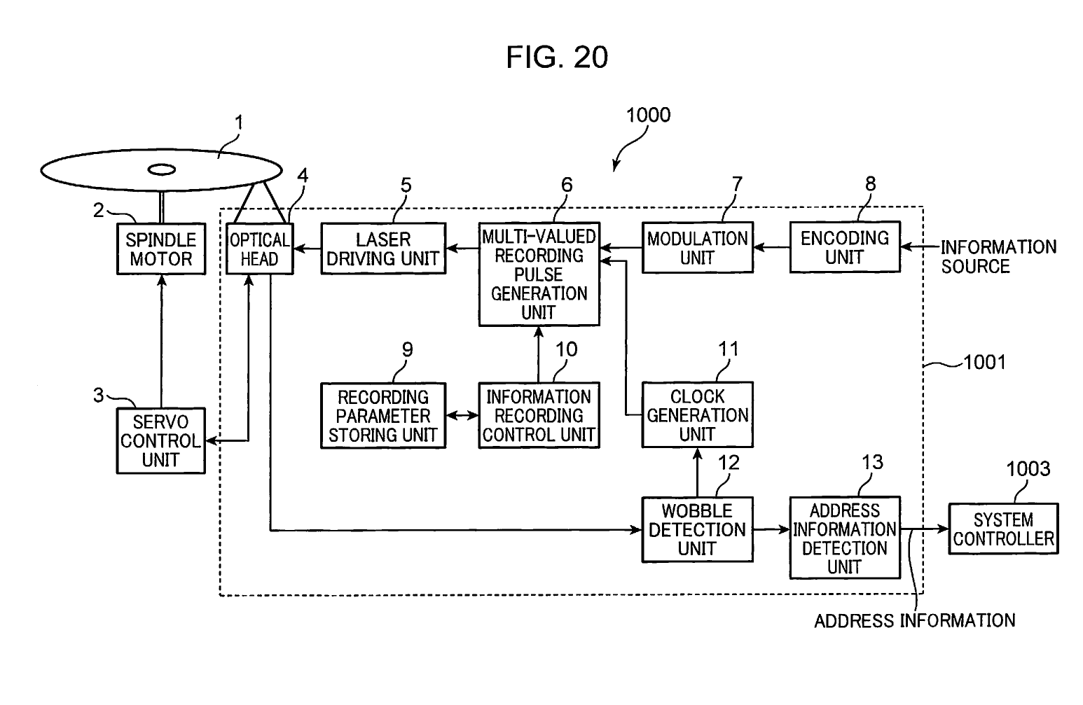

FIG. 20 is a block diagram depicting the configuration of the information recording apparatus according to this embodiment.

In FIG. 20, the information recording apparatus 1000 has a spindle motor 2, a servo control unit 3, a recording unit 1001 and a system controller 1003. The recording unit 1001 in this embodiment has an optical head 4, a laser driving unit 5, a multi-valued recording pulse generation unit 6, a modulation unit 7, an encoding unit 8, a recording parameter storing unit 9, an information recording control unit 10, a clock generation unit 11, a wobble detection unit 12, and an address information detection unit 13. The wobble detection unit 12 and the address information detection unit 13 can be used not only for recording operation, but also for reproducing operation.

The information recording medium 1 is mounted on a turntable (not illustrated), and is rotary-driven by the spindle motor 2 at a predetermined rotation speed during recording operation or reproducing operation.

As mentioned above, the information recording medium 1 has periodically formed concave or convex pits. A laser beam is irradiated onto the pit string constituted by the plurality of pits and changes the shape of the pits, whereby information is recorded on the information recording medium 1. If the pits are concave, the length of each pit in the depth direction decreases as the intensity of the laser beam irradiated onto the pits increases. If the pits are convex, for example, the length of each pit in the height direction decreases as the intensity of the laser beam irradiated onto the pits increases. The pit string constituted by the plurality of pits wobbles at a wobble period fwbl. The address information is recorded by frequency modulation of the wobble period. The length of the period of the pits is the diffraction limit or less. The period of the pit string is n times (n is a positive integer) of the period of the pits.

The servo control unit 3 generates a focus error signal and a tracking error signal based on the reproduced signal outputted from the optical head 4, and performs focus control and tracking control of the optical head 4. The servo control unit 3 also performs rotation control of the spindle motor 2.

The optical head 4 irradiates a laser beam on the information recording medium 1. The optical head 4 also generates a reproduced signal by electrically converting the reflected light from the information recording medium 1. The reproduced signal according to this embodiment includes a signal generated by electrically converting the reflected light from the information recording medium 1 during recording operation of the information recording apparatus 1000.

The wobble detection unit 12 detects a wobble signal based on the reproduced signal outputted from the optical head 4. As mentioned above, the reproduced signal includes a wobble signal.

The wobble period fwbl has been set in advance. Therefore the wobble detection unit 12, which is constituted by a bandpass filter for passing only a frequency band corresponding to the wobble period fwbl, can detect a wobble signal.

In this embodiment, the information recording medium 1 records address information by modulation of the wobble signal. Therefore the wobble signal for detecting the address information is detected by a bandpass filter for passing the frequency band corresponding to the modulation method for recording the address information.

The clock generation unit 11 generates a recording clock based on the wobble signal outputted from the wobble detection unit 12. The wobble signal is constituted by a wobble period fwbl which is a predetermined period. Therefore the clock generation unit 11 generates a clock signal synchronizing with the information recording medium 1 by performing PLL (Phase Locked Loop) control based on the wobble period fwbl. The clock signal is generated as a reference clock in each control block of the information recording apparatus 1000, and is used as a recording clock or a reproducing clock.

The frequency of the clock signal is higher than the frequency of the wobble period fwbl, and is the frequency of the pit period fp or more.

The address information detection unit 13 demodulates address information based on the wobble signal outputted from the wobble detection unit 12. For example, if the modulation of the wobble signal is frequency modulation, the address information detection unit 13 performs demodulation processing for the frequency modulation and generates binary “0” and “1” data, whereby address information is detected. Before the address information as binary data is recorded on the information recording medium 1, error correction encoding processing may be performed on the binary data. In this case, the address information detection unit 13 decodes address information, by further executing error correction decoding processing on the generated binary data.

The system controller 1003 controls the operation of the entire apparatus. The system controller 1003 records the information in a predetermined address on the information recording medium 1 based on the address information demodulated by the address information detection unit 13. In other words, based on the address information, the system controller 1003 moves the optical head 4 to an area corresponding to the predetermined address on the information recording medium 1.

The encoding unit 8 outputs recording data generated by attaching an error correcting code (ECC) to the user data, which is the information source.

The modulation unit 7 performs digital modulation processing on the recording data where the error correcting code is attached, and generates modulated data. The modulation unit 7 further converts the modulated data into a multi-valued pattern (three or more values) to indicate a multi-valued level.

The multi-valued recording pulse generation unit 6 generates a recording pulse based on a recording clock, and corrects the recording power, pulse width or the like of the recording pulse, according to the multi-valued pattern.

The multi-valued pulse generation unit 6 also sets the recording unit time in the multi-valued recording to an integral multiple of the recording clock. The integral multiple is a predetermined value. The multi-valued pulse generation unit 6 sets the integral multiple based on the ratio of the period of the pits and the period of the recording clock.

For example, if the recording clock is generated at a same period as the pit period fp and the recording unit time is set to a times (a is 1 or greater integer) of the pit period fp, the integral multiple is a. For example, if the recording clock is generated at a period that is at 1/b times (b is 1 or greater integer) of the pit period fp, and the recording unit time is set to a times of the pit period fp, then the integral multiple is a×b. In this case, a or b may be a real number as long as a×b is an integer.

Since the integral multiple is set according to the ratio of the pit period fp and the period of the recording clock like this, the information can be recorded corresponding to the pit period. The recording unit time in this embodiment need not always match with the pit period fp. However matching the recording unit time with the pit period fp is the best mode to decrease recording dispersion. The recording unit time may be set to a short time. For example, if the length of the pit and the length of the space are the same, and recording control is performed using only the pits, then the recording unit time is set to ½ of the time of the pit period fp, and recording conditions are switched for the pit or for the space.

The laser driving unit 5 controls power of the laser beam irradiated from the optical head 4.

The setting values of recording conditions (e.g. recording power, recording pulse) according to a number of level changes of the multi-valued pattern are stored in the recording parameter storing unit 9. For example, if the multi-valued level of the multi-valued pattern is eight levels, the recording parameter storing unit 9 stores eight types of recording power or pulse width of the recording pulse (recording conditions). The recording energy in each recording condition is higher than the energy required for reproduction.

It is preferable that each setting value of the recording conditions is set corresponding to the type of the information recording medium 1. This is because the recording characteristics are different depending on the type of the information recording medium 1. The type of the information recording medium 1 is discerned by the medium information (e.g. manufacturer, rewritable or write once type, single layer or double layer, recording capacity) written in the information area 101 of the information recording medium 1. For the setting values of the recording conditions, the recording conditions recorded in the information area 101 of the information recording medium 1 may be used. In this case, the circuit scale can be reduced since the recording parameter storing unit 9 is unnecessary. The information recording control unit 10 acquires the setting value of the recording power or the pulse width according to the number of level changes of the multi-valued pattern, from the recording parameter storing unit 9, based on the medium information of the information recording medium 1 on which multi-valued recording is performed. Then the information recording control unit 10 controls the multi-valued recording pulse generation unit 6 such that the recording pulse generated by the multi-valued recording pulse generation unit 6 has the acquired setting value of the recording power or the pulse width.

If information is recorded using a recording pulse instead of DC emission, the pulse width of the recording pulse must be set to a predetermined value (e.g. 2.0 ns) or longer depending on the rise (Tr)/fall (TO characteristics of the laser beam. Further, in the setting of the recording conditions, the setting resolution of the recording power is finer than the pulse width of the recording pulse. Therefore in this embodiment, it is preferable to use the recording power for the recording conditions to be changed according to the multi-valued pattern. The change of the pulse width of the recording pulse may be used for fine adjustment of the recording conditions.

In this embodiment, the information recording apparatus 1000 corresponds to an example of the information recording apparatus, the information recording medium 1 corresponds to an example of the information recording medium, the wobble detection unit 12 corresponds to an example of the wobble detection unit, the clock generation unit 11 corresponds to an example of the clock generation unit, the multi-valued recording pulse generation unit 6 corresponds to an example of the setting unit, the address information detection unit 13 corresponds to an example of the address information demodulation unit, and the system controller 1003 corresponds to an example of the information recording unit.

Now the recording operation of the information recording apparatus 1000 in FIG. 20 will be described.

First the information recording medium 1 is mounted on the information recording apparatus 1000, and is rotated at a constant linear velocity (CLV) or at a constant angular velocity (CAV) by the spindle motor 2.

Then the optical head 4 irradiates a laser beam onto the information recording medium 1. The optical head 4 irradiates a laser beam of which output is lower than the recording power, since recording operation is not performed at this point. The optical head 4 receives reflected light from the information recording medium 1 on which the laser beam was irradiated, and generates a reproduced signal. The servo control unit 3 controls the focus of the optical head 4 based on the reproduced signal, so that the focal point of the laser beam is on the recording layer of the information recording medium 1. The servo control unit 3 also controls tracking of the optical head 4, so that the spot of the laser beam follows up the pit string.

The wobble detection unit 12 receives the reproduced signal from the optical head 4, and generates a wobble signal.

The clock generation unit 11 generates a recording clock based on the wobble signal outputted from the wobble detection unit 12. The address information detection unit 13 demodulates the address information based on the wobble signal outputted from the wobble detection unit 12. The system controller 1003 records or reproduces the information in the predetermined address based on the demodulated address information.

The information recording apparatus 1000 acquires the medium information written in the information area 101 of the information recording medium 1. Based on the acquired medium information, the information recording control unit 10 selects the setting values of the recording conditions stored in the recording parameter storing unit 9. The information recording control unit 10 acquires the selected setting values of the recording conditions.

During recording, the system controller 1003 moves the optical head 4 to a recording target area of the data area 102 based on the address information.

The encoding unit 8 generates and outputs recording data generated by attaching an error correcting code to the user data, which is the information source. The modulation unit 7 modulates the recording data outputted from the encoding unit 8, and converts the modulated recording data to a multi-valued pattern.

The multi-valued pulse generation unit 6 receives the recording clock generated by the clock generation unit 11, and receives the multi-valued pattern generated by the modulation unit 7, and generates the recording pulse. The multi-valued recording pulse generation unit 6 also sets the recording unit time in the multi-valued recording to an integral multiple of the recording clock based on the medium information.

At this time, the information recording control unit 10 controls the multi-valued recording pulse generation unit 6, so that the recording pulse which the multi-valued recording pulse generation unit 6 generates according to the multi-valued pattern, becomes the setting values of the recording conditions.

The laser driving unit 5 controls the optical head 4, based on the recording pulse controlled by the information recording control unit 10, so that the laser beam according to each recording pulse is outputted.

In this way, the information recording apparatus 1000 changes the degree of transformation of the pits and performs multi-valued recording, by changing the setting values of the recording conditions according to the multi-valued pattern for the information recording medium 1 on which pit strings are formed.

The pit string is periodically wobbled, and the address information is recorded by modulating the wobble signal generated by wobbling of the pit string. Therefore the information recording apparatus 1000 can record or reproduce information in a predetermined address of the information recording medium 1.

Furthermore, since the recording clock is generated based on the wobble signal, a clock signal, synchronizing with the information recording medium 1, can be generated. Thereby readability during reproduction can be improved.

For example, if a plurality of information recording apparatuses records information on the respective information recording medium 1 using an internal recording clock of the information recording apparatus, the reproducing clock, generated from the reproduced signal during reproduction, disperses, since the frequency and phase of the recording clock disperses in each information recording apparatus. Therefore if each information recording apparatus generates the recording clock from the wobble signal, the dispersion of the recording clock inside the information recording apparatus is suppressed. As a result, when the information in the recording area, recorded by each information recording apparatus, is reproduced, the reproduced signal can be processed without the reproducing clock fluctuating at a point where each recording area is switched, for example.

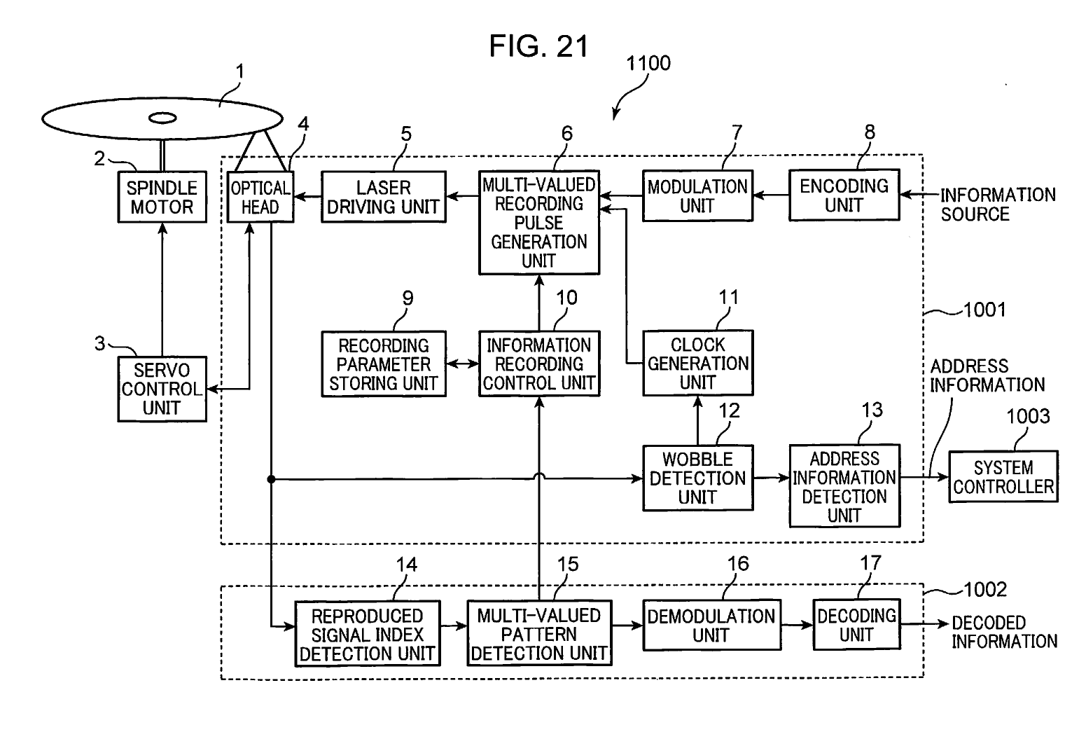

FIG. 21 is a block diagram depicting the configuration of the information recording/reproducing apparatus according to this embodiment. The information recording/reproducing apparatus 1100 has a spindle motor 2, a servo control unit 3, a recording unit 1001, a reproducing unit 1002 and a system controller 1003.

The information recording/reproducing apparatus 1100 has the configuration of the information recording apparatus 1000 shown in FIG. 20, to which a reproducing unit 1002 is added, and has a reproduction function for reproducing information which was recorded by multi-valued recording on the information recording medium 1. Hence in FIG. 21, a same composing element as the information recording apparatus 1000 in FIG. 20 is denoted with a same reference symbol, for which description is omitted, and only the reproducing unit 1002 will be described.

The reproducing unit 1002 has a reproduced signal index detection unit 14, a multi-valued pattern detection unit 15, a demodulation unit 16 and a decoding unit 17.

The reproduced signal index detection unit 14 receives a reproduced signal outputted from the optical head 4, and detects a ratio of the change of the amplitude or signal level of the reproduced signal that is caused by the change of the shape of the pits (hereafter index value).

The index value of the reproduced signal may be detected either by analog signal processing or by digital signal processing. However digital signal processing is more desirable than analog signal processing since the recording unit time for multi-valued recording is short, that is, the time interval for the reproduced signal to change is short. In the case of the digital signal processing, the reproduced signal index detection unit 14 generates a digital signal by A/D conversion, which is performed on the reproduced signal outputted from the optical head 4 based on the reproducing clock.

For example, if the index value is the change of the amplitude of the reproduced signal, the reproduced signal index detection unit 14 detects the amplitude of the reproduced signal from the peak value of the digital signal in each recording unit time. The reproduced signal index detection unit 14 detects the change of the amplitude under each recording condition, based on the amplitude of an unrecorded reproduced signal or on the amplitude of the reproduced signal under the recording conditions where the heating value on the pits is the lowest.

If the index value is a signal level of the reproduced signal, for example, the reproduced signal index detection unit 14 detects a digital signal in each recording unit time. The reproduced signal index detection unit 14 detects the change of the signal level under each recording condition based on the amplitude of an unrecorded reproduced signal or on the amplitude of the reproduced signal under the recording conditions of which the heating value on the pits is lowest.

The multi-valued pattern detection unit 15 generates a multi-valued pattern based on the index value detected by the reproduced signal index detection unit 14.

Since the index value changes according to the multi-valued level, the multi-valued pattern detection unit 15 can detect a multi-valued pattern corresponding to the multi-valued level which has been set in advance, by identifying the index value. In order to increase detection accuracy of the multi-valued pattern, the multi-valued pattern detection unit 15 may apply PRML (Partial Response Maximum Likelihood) type signal processing.

The demodulation unit 16 converts the multi-valued pattern detected by the multi-valued pattern detection unit 15 into modulated data, and demodulates the modulated data to generate demodulated data.

The decoding unit 17 performs error correction processing on demodulated data generated by the demodulation unit 16, and outputs decoded information generated by decoding the recorded information.

In this way, the information recording/reproducing apparatus 1100 can reproduce information that is recorded by multi-valued recording on the information recording medium 1.

The multi-valued pattern detection unit 15 may determine an ideal index value for a detected multi-valued pattern, and detect a difference between a detected index value and the ideal index value. For example, the multi-valued pattern detection unit 15 predicts an ideal index value from index values that change at equal intervals in the multi-value pattern. The multi-valued pattern detection unit 15 outputs the difference of the index value to the information recording control unit 10. The information recording control unit 10 corrects the setting values of the recording conditions so that the difference of the index value decreases. By adjusting the recording conditions like this, the recording accuracy of the multi-valued recording can be improved. In this case, an area for adjusting the multi-valued recording conditions may be set on the information recording medium 1.

An embodiment of the present invention was described above with reference to the drawings.

The information recording medium according to this embodiment was described as the information recording medium where reflected light quantity decreases when the pits transform, but can also be applied to an information recording medium where reflected light quantity increases when the pits transform.

The change of the reproduced signal due to the multi-valued recording in this embodiment is detected based on the reflected light quantity from the pits, but may be detected based on the transmitted light quantity, or may be detected based on the phase of the reflected light or the phase of the transmitted light. The detection based on the phase is effective when noise is high with respect to the amplitude of the reproduced signal, that is, when the SN (Signal-noise) ratio is poor.

The information recording medium, the information recording method and the information recording apparatus according to this embodiment were described assuming three values or more of multi-valued recording, but can be applied to binary recording as well.

The above mentioned embodiment mainly includes an invention having the following configuration.

An information recording medium according to an aspect of the present invention is an information recording medium having a plurality of pits which are formed periodically, wherein information is recorded by irradiating a laser beam onto a pit string constituted by the plurality of pits and changing the shape of the pits, the pit string is periodically wobbled, a length of a period of the pits is a diffraction limit of the laser beam or less, and the period of the pit string is n times (n is a positive integer) of the period of the pits.

According to this configuration, the pit string constituted by the plurality of pits periodically wobbles, the length of the period of the pits is the diffraction limit of the laser beam or less, and the period of the pit string is n times (n is a positive integer) of the period of the pits.

Since the length of the period of the pits is the diffraction limit of the laser beam or less, information can be recorded in short recording units, and information can be recorded at high density. Furthermore, the pit string periodically wobbles and the period of the pit string is n times (n is a positive integer) of the period of the pits, therefore accurate timing information, to record information in the pits, can be acquired from the period of the pit string when the period of the pits is shorter than the optical resolution, and information can be recorded stably.

In this information recording medium, it is preferable that address information of the information recording medium is recorded by modulation based on the wobbling of the pit string.

According to this configuration, the address information of the information recording medium is recorded by modulation based on the wobbling of the pit string, hence the address information can be detected from the pit string, even if the information recording medium is in an unrecorded state, where information is not recorded in the recording area.

In this information recording medium, it is preferable that the shape of the pits changes so as to correspond to information in binary or more.

According to this configuration, the shape of the pits changes so as to correspond to information in binary or more, hence multi-valued recording, where the shape of the pits are changed at multiple levels, can be performed by irradiating a laser beam changing the recording power.

An information recording method according to another aspect of the present invention is an information recording method for recording information on an information recording medium, wherein the information recording medium has a plurality of pits which are formed periodically, and information is recorded on the information recording medium by irradiating a laser beam onto a pit string constituted by the plurality of pits and changing the shape of the pits, the pit string is periodically wobbled, a length of a period of the pits is a diffraction limit of the laser beam or less, and the period of the pit string is n times (n is a positive integer) of the period of the pits, the information recording method comprising: a wobble detection step of detecting a wobble signal from the information recording medium; a clock generation step of generating a recording clock from the wobble signal detected in the wobble detection step; and a setting step of setting a recording unit time for recording the information to an integral multiple of the recording clock generated in the clock generation step.

According to this configuration, the information recording medium has a plurality of pits which are formed periodically, and information is recorded by irradiating a laser beam onto a pit string constituted by the plurality of pits and changing the shape of the pits. The pit string is periodically wobbled, the length of the period of the pits is the diffraction limit of the laser beam or less, and the period of the pit string is n times (n is a positive integer) of the period of the pits. In the wobble detection step, a wobble signal is detected from the information recording medium. In the clock generation step, a recording clock is generated from the wobble signal detected in the wobble detection step. In the setting step, a recording unit time for recording the information is set to an integral multiple of the recording clock generated in the clock generation step.

Since the length of the period of the pits is the diffraction limit of the laser beam or less, information can be recorded in short recording units, and information can be recorded at high density. Furthermore, the pit string periodically wobbles and the period of the pit string is n times (n is a positive integer) of the period of the pits, therefore accurate timing information, to record information in the pits, can be acquired from the period of the pit string when the period of the pits is shorter than the optical resolution, and information can be recorded stably.

In this information recording method, it is preferable that the integral multiple is set based on the ratio of the period of the pits and the period of the recording clock in the setting step.

According to this configuration, the integral multiple is set based on a ratio of the period of the pits and the period of the recording clock in the setting step, hence information can be recorded corresponding to the period of the pits.

In this information recording method, it is preferable that address information of the information recording medium is recorded on the information recording medium by modulation of the wobble signal, and the information recording method further comprises: an address information demodulation step of demodulating the address information based on the wobble signal detected in the wobble detection step; and an information recording step of recording the information in a predetermined address of the information recording medium based on the address information demodulated in the address information demodulation step.

According to this configuration, address information of the information recording medium is recorded on the information recording medium by modulation of the wobble signal. In the address information demodulation step, the address information is demodulated based on the wobble signal detected in the wobble detection step. In the information recording step, the information is recorded in a predetermined address of the information recording medium based on the address information demodulated in the address information demodulation step.

Since the address information of the information recording medium is recorded by modulation based on the wobbling of the pit string, the address information can be detected from the pit string, even if the information recording medium is in an unrecorded state, where information is not recorded in the recording area.

An information recording apparatus according to another aspect of the present invention is an information recording apparatus for recording information on an information recording medium, wherein the information recording medium has a plurality of pits which are formed periodically and information is recorded on the information recording medium by irradiating a laser beam onto a pit string constituted by the plurality of pits and changing the shape of the pits, the pit string is periodically wobbled, a length of a period of the pits is a diffraction limit of the laser beam or less, and the period of the pit string is n times (n is a positive integer) of the period of the pits, the information recording apparatus comprising: a wobble detection unit that detects a wobble signal from the information recording medium; a clock generation unit that generates a recording clock from the wobble signal detected by the wobble detection unit; and a setting unit that sets a recording unit time for recording the information to an integral multiple of the recording clock generated by the clock generation unit.

According to this configuration, the information recording medium has a plurality of pits which are formed periodically, and information is recorded by irradiating a laser beam onto a pit string constituted by the plurality of pits and changing the shape of the pits. The pit string is periodically wobbled, the length of the period of the pits is the diffraction limit of the laser beam or less, and the period of the pit string is n times (n is a positive integer) of the period of the pits. The wobble detection unit detects a wobble signal from the information recording medium. The clock generation unit generates a recording clock from the wobble signal detected by the wobble detection unit. The setting unit sets a recording unit time for recording the information to an integral multiple of the recording clock generated by the clock generation unit.

Since the length of the period of the pits is the diffraction limit of the laser beam or less, information can be recorded in short recording units, and information can be recorded at high density. Furthermore, the pit string periodically wobbles and the period of the pit string is n times (n is a positive integer) of the period of the pits, therefore accurate timing information, to record information in the pits, can be acquired from the period of the pit string when the period of the pits is shorter than the optical resolution, and information can be recorded stably.

In this information recording apparatus, it is preferable that the setting unit sets the integral multiple based on a ratio of the period of the pits and the period of the recording clock.

According to this configuration, the setting unit sets the integral multiple based on a ratio of the period of the pits and the period of the recording clock, hence information can be recorded corresponding to the period of the pits.

In this information recording apparatus, it is preferable that address information of the information recording medium is recorded on the information recording medium by modulation of the wobble signal, and the information recording apparatus further comprises: an address information demodulation unit that demodulates the address information based on the wobble signal detected by the wobble detection unit; and an information recording unit that records the information in a predetermined address of the information recording medium based on the address information demodulated by the address information demodulation unit.

According to this configuration, address information of the information recording medium is recorded on the information recording medium by modulation of the wobble signal. The address information demodulation unit demodulates the address information based on the wobble signal detected by the wobble detection unit. The information recording unit records the information in a predetermined address of the information recording medium based on the address information demodulated by the address information demodulation unit.

Since the address information of the information recording medium is recorded by modulation based on the wobbling of the pit string, the address information can be detected from the pit string, even if the information recording medium is in an unrecorded state, where information is not recorded in the recording area.

The embodiments and examples described in the section “Description of Embodiments” are merely illustrative to clarify techniques of the present invention and are not intended to limit the invention to these examples, and numerous modifications and variations can be made without departing from the true spirit and scope of the Claims of the invention.

### INDUSTRIAL APPLICABILITY

The present invention allows to record information at high density and record information stably, and is useful for an information recording medium having a plurality of pits which are formed periodically, wherein information is recorded by irradiating a laser beam onto a pit string constituted by the plurality of pits, and changing the shape of the pits, an information recording method for recording information on the information recording medium, and an information recording apparatus for recording information on the information recording medium.

The present invention can also be applied to an information recording method and information recording apparatus for recording multi-valued data on a part of a conventional information recording medium where binary data is optically recorded, such as DVD-RAM, BD-RE and other information recording media.

1. An information recording medium having a plurality of pits which are formed periodically, wherein
information is recorded by irradiating a laser beam onto a pit string constituted by the plurality of pits and changing the shape of the pits,
the pit string is periodically wobbled,
a length of a period of the pits is a diffraction limit of the laser beam or less, and
the period of the pit string is n times (n is 2 or greater integer) of the period of the pits.

2. The information recording medium according to claim 1, wherein
address information of the information recording medium is recorded by modulation based on the wobbling of the pit string.

3. The information recording medium according to claim 1, wherein
the shape of the pits changes so as to correspond to information in binary or more.

4. An information recording method for recording information on an information recording medium, wherein
the information recording medium has a plurality of pits which are formed periodically, and information is recorded on the information recording medium by irradiating a laser beam onto a pit string constituted by the plurality of pits and changing the shape of the pits,
the pit string is periodically wobbled,
a length of a period of the pits is a diffraction limit of the laser beam or less, and
the period of the pit string is n times (n is 2 or greater integer) of the period of the pits, the information recording method comprising:
a wobble detection step of detecting a wobble signal from the information recording medium;
a clock generation step of generating a recording clock from the wobble signal detected in the wobble detection step; and
a setting step of setting a recording unit time for recording the information to an integral multiple of the recording clock generated in the clock generation step.

5. The information recording method according to claim 4, wherein
in the setting step, the integral multiple is set based on a ratio of the period of the pits and the period of the recording clock.

6. The information recording method according to claim 4, wherein
address information of the information recording medium is recorded on the information recording medium by modulation of the wobble signal,
the information recording method further comprising:
an address information demodulation step of demodulating the address information based on the wobble signal detected in the wobble detection step; and
an information recording step of recording the information in a predetermined address of the information recording medium based on the address information demodulated in the address information demodulation step.

7. An information recording apparatus for recording information on an information recording medium, wherein
the information recording medium has a plurality of pits which are formed periodically, and information is recorded on the information recording medium by irradiating a laser beam onto a pit string constituted by the plurality of pits and changing the shape of the pits,
the pit string is periodically wobbled,
a length of a period of the pits is a diffraction limit of the laser beam or less, and
the period of the pit string is n times (n is 2 or greater integer) of the period of the pits, the information recording apparatus comprising:
a wobble detection unit that detects a wobble signal from the information recording medium;
a clock generation unit that generates a recording clock from the wobble signal detected by the wobble detection unit; and
a setting unit that sets a recording unit time for recording the information to an integral multiple of the recording clock generated by the clock generation unit.

8. The information recording apparatus according to claim 7, wherein
the setting unit sets the integral multiple based on a ratio of the period of the pits and the period of the recording clock.

9. The information recording apparatus according to claim 7, wherein
address information of the information recording medium is recorded on the information recording medium by modulation of the wobble signal,
the information recording apparatus further comprising:
an address information demodulation unit that demodulates the address information based on the wobble signal detected by the wobble detection unit; and
an information recording unit that records the information in a predetermined address of the information recording medium based on the address information demodulated by the address information demodulation unit.
